(19) United States
(12) Patent Application Publication
(10) Pub. No.: US 2001/0028137 A1
(43) Pub. Date: Oct. 11, 2001

(54) Securing element for dampened securement of components

(75) Inventors: Gunter Eberhard, Gehrden (DE); Bernhard Uhrmeister, Hannover (DE)

Correspondence Address: ROBERT W. BECKER & ASSOCIATES, 11896 N. Highway 14, Suite B, Tijeras, NM, 87059, US

(73) Assignee: ContiTech Vibration Control GmbH, Hannover (DE)

(21) Appl. No.: 09/827,828

(22) Filed: Apr. 5, 2001

(30) Foreign Application Priority Data
Apr. 5, 2000 (DE) 100 167 05.5

(51) Int. Cl. F16F 5/00; F16M 5/00

(52) U.S. Cl. 267/140.13

(57) ABSTRACT

A securing element for dampened securement of a group of components one to another and, in particular, for dampened securement of drive components of trucks, is provided and includes a housing, a support body, an deformable enclosure enclosing a fluid volume and an elastomeric load bearing body which, in one operational condition, supports the entire mass of the group of components without being operatively coupled to the support body in a manner which brings the support body into load bearing duty and which, in another operational condition, cooperatively acts with the support body. The securing element also includes a control device operable to effect a decoupling of the load bearing body and the support body from one another and operable, in another control operation, to effect a coupling of the load bearing body and the support body with one another such that both cooperate together in supporting the load.

### BACKGROUND OF THE INVENTION

The present invention relates to a securing element for dampened securement of a group of components one to another including dampened securement of drive components of trucks.

German patent document DE 34 41 592 C2 describes a hydraulically damped elastic support whose damping operation can be controllably activated and deactivated. In this configuration, a damping fluid of the support is contained between membranes of which an upper membrane thereof is disposed at a spacing from a rubber damping element or is alternatively in contact with this rubber damping element such that there exists either a pure rubber damping element or, on the other hand, a fluid support; a good accommodation of the support to various loading situations is thereby realized.

### SUMMARY OF THE PRESENT INVENTION

The present invention provides a solution to the challenge of further developing the state of the art of fluid supports so as to improve the capability to adapt the support to various operational environments or, respectively, operational conditions, of the group of components to be supported.

In accordance with the present invention, a solution is provided in that the securing element includes an elastomeric load bearing body which, in one operational condition of the securing element, supports the entire mass of the group of components without being operatively coupled to the support body in a manner which brings the support body into load bearing duty and which, in another operational condition of the securing element, cooperatively acts with the support body and additionally includes a control device operable, in one control operation, to effect a decoupling of the load bearing body and the support body from one another, via spaced apart disposition thereof or the creation of a free space therebetween, in a manner such that the load bearing body supports the entire mass of the group of components and operable, in another control operation, to effect a coupling of the load bearing body and the support body with one another such that both cooperate together in supporting the load.

The securing element of the present invention has the advantage that the stiffness of an elastic support can be varied independently of the forces, turning moments, and oscillations acting on the support.

In a preferred embodiment of the securing element of the present invention, the fluid volume, which is flexibly enclosed in the securing element and which acts as a damping element, is disposed between the load bearing body and the support body so that the load bearing body, in the other noted control operation, acts on the fluid volume, whereby a coupling of the load bearing body and the support body with one another is effected.

Alternatively, the flexibly retained fluid volume can be disposed on a side of the support body which is not oriented toward the load bearing body so that, in the other noted control operation, the load bearing body is in at least partial direct contact with the support body and thereby forms together with the support body a unitary support body.

If, in connection with a disposition of the fluid volume on a side of the support body which is not oriented toward the load bearing body, the fluid volume is enclosed in a membrane which acts to retain the fluid volume at a spacing from the support body, an elastic support can be realized with or without damping or, additionally, with or without a controllably actuable stiffness.

In accordance with a preferred embodiment of the securing element of the present invention, the load bearing body has a hollow conical shape and is connected at its outer periphery with the housing. To reduce or prevent operating noise occurring during change between the control operations, the load bearing body can be configured such that its inwardly oriented, concavely curved surface, starting at the outer periphery, comes into contact in a progressive uninterrupted manner with a correspondingly configured surface of the support body or with the membrane enclosing the fluid volume in the working chamber.

In one embodiment of the securing element of the present invention in which the flexible enclosed fluid volume is disposed between the support body and the load bearing body, the securing element includes a control device which provides a control capability in permitting, at a predetermined pressure equalization with the atmospheric pressure, variation of the amount of fluid in the securing element so that the membrane can be selectively disposed in contact with the load bearing body or disposed at a spacing from the load bearing body.

### BRIEF DESCRIPTION OF THE DRAWINGS

The object and advantages of the present invention will appear more clearly from the following specification in conjunction with the accompanying schematic drawings, in which:

FIG. 1 is a sectional view of one embodiment of the securing element of the present invention having a capability to vary the stiffness of the thereadjacent elastomeric damping body; and

FIG. 2 is a sectional view of another embodiment of the securing element of the present invention having a damping element disposed between the elastomeric damping bodies.

### DETAILED DESCRIPTION OF THE PREFERRED EMBODIMENTS

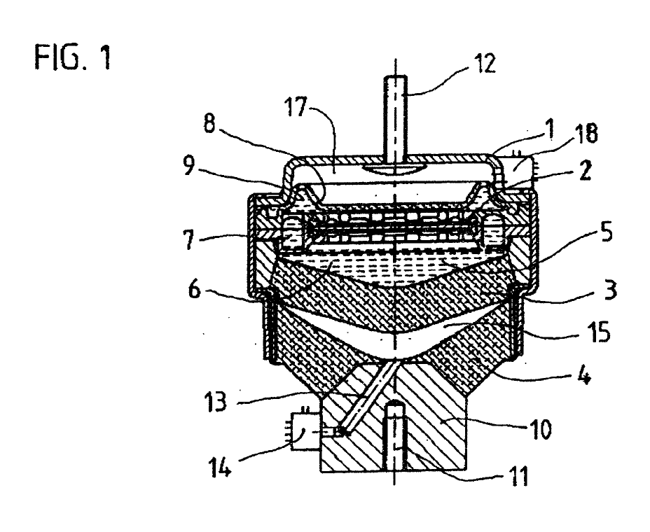

FIG. 1 shows one embodiment of the securing element of the present invention which principally comprises a pot-type housing 1, a damping element 2 housed within the housing 1, a support body 3 for damping engagement of the damping element 2, and a load bearing body 4. The damping element 2 is configured in a conventional manner to the extent that the movement of the support body 3 in the course of a damping operation extent effects the flow of a fluid 5 out of a working chamber 6, through an overflow channel 7, and into an equalization chamber 9 which is capped by a cap membrane 8 as well as the flow of the fluid 5 in a reverse path through the noted components. It is accordingly within the scope of the present invention to provide a separation of the fluid from the support body 3 via an additional membrane (not shown) and an additional control device so as to thereby offer the possibility, in connection with either a configuration in which the additional membrane is in contact with the support body 3 or another configuration in which the additional membrane is spaced from the support body 3, to damp the oscillations of the support body 3 and the load bearing body 4 including damping the oscillations completely.

The load bearing body 4 is located on the respective side of the support body 3 which faces away from the fluid and the load bearing body, which has a hollow conical shape, is connected along its outer circumference with the housing 1, and supports a bearing insert 10.

The bearing insert 10 includes a threaded bore 11 for threadably receiving therein a securing element to thereby connect the bearing with the drive assembly or the bearing block of the drive assembly. To provide a similar connecting capability, a bolt 12 is mounted on the side of the bearing opposite the side on which the threaded bore 11 is formed.

The bearing insert 10 includes a throughbore 13, which is communicated with a control device 14.

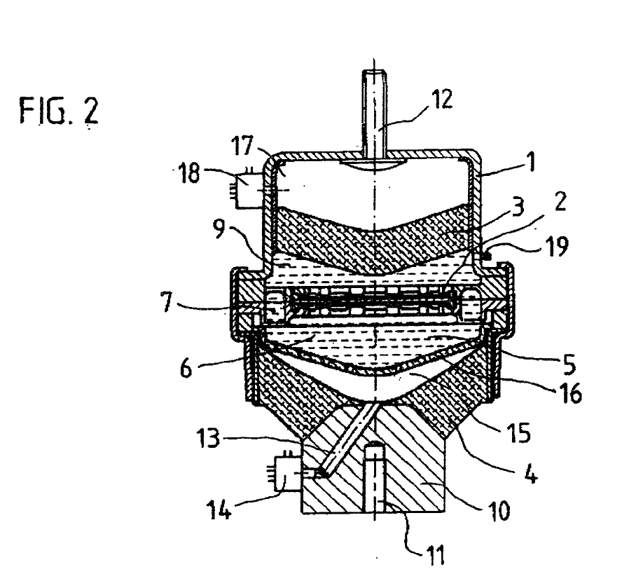

FIG. 2 shows another embodiment of the elastic securing element of the present invention in which the damping element, which comprises a working chamber 6, an overflow channel 7, and an equalization chamber 9, is not, in contrast to the one embodiment of the securing element of the present invention shown in FIG. 1, located serially following the load bearing body 4 and the support body 3 but is, instead, located between the load bearing body 4 and the support body 3. The function performed by the cap membrane 8 in the one embodiment of the securing element of the present invention shown in FIG. 1 is performed instead by the support body 3 in then another embodiment of the element shown in FIG. 2. To ensure unhindered damping operation of the support body 3, a control device 18 is provided to produce a pressure equalization with the ambient atmosphere.

In one operational condition of a damping operation of either the one embodiment of the securing element of the present invention shown in FIG. 1 or the another embodiment of the element shown in FIG. 2, a free space 15 exists between, respectively, the load bearing body 4 and the support body 3 (FIG. 1) or the load bearing body 4 and the membrane 16 which forms a border of the working chamber 6 (FIG. 2). In this one operational condition, solely the load bearing body 4 takes the loading with comparatively reduced stiffness and without any damping operation.

In the event that a static load effects movement of the load bearing body 4 into contact with the support body 3 (FIG. 1) or the membrane 16 (FIG. 2), there are a number of possible approaches to effecting a separation of the load bearing body 4 from, respectively, the support body 3 or the membrane 16. This separation can be effected by producing an overpressure in the border area between, respectively, the support body 3 and the load bearing body 4 (FIG. 1) or the load bearing body 4 and the membrane 16 (FIG. 2) by, for example, introducing air. There exists the further possibility of achieving this operational condition by operating the control device 18 to effect the evacuation of the free open area 17, which borders on the one closed end of the housing 1. In this connection, it is advantageous if the control device 14 and the control device 18 are operationally interconnected such that, for example, the control device 14 controls, in connection with the evacuation of the free open area 17, the opening of the throughbore 13 to the atmosphere for an equalization of the free space 15 or effects the creation of an overpressure in the free space 15.

In the event that the loading on the element leads to another operational condition of the element different than its above-noted one operational condition, then, in this other operational condition, the load bearing body 4 and the support body 3 are in contact with one another (FIG. 1) or the load bearing body 4 and the membrane 16 are in contact with one another (FIG. 2) and there occurs, as compared with the one operational condition, an increased stiffness of the bearing due to the coupling of the load bearing body 4 and the support body 3 as well as a damping of the oscillations at a predetermined frequency range due to the conventional effect of flowing fluid in a hydraulic bearing.

This other operational condition of the element can be achieved as well in a static damping situation. In the event that there the free space 15 still exists in a static loading situation between, respectively, the load bearing body 4 and the support body 3 or the load bearing body 4 and the membrane 16, the second operational condition can be implemented by evacuation of the free space 15. This second operational condition can be implemented, for example, in connection with then another embodiment of the element shown in FIG. 2, by flow of fluid via an inlet 19 into the flexibly enclosed fluid volume until the membrane 16 is in contact with the load bearing body 4. In this manner, a pressure equalization with the ambient atmosphere is produced by controlled opening and closing of the throughbore 13 by the control device 14.

The specification incorporates by reference the disclosure of German priority document 100 167 05.5 of Apr. 5, 2000.

The present invention is, of course, in no way restricted to the specific disclosure of the specification and drawings, but also encompasses any modifications within the scope of the appended claims.

What we claim is:

1. A securing element for dampened securement of a group of components one to another including dampened securement of drive components of trucks, comprising:
a housing;
a support body;
an enclosure enclosing a fluid volume, the enclosure being deformable;
an elastomeric load bearing body which, in one operational condition of the securing element, supports the entire mass of the group of components without being operatively coupled to the support body in a manner which brings the support body into load bearing duty and which, in another operational condition of the securing element, cooperatively acts with the support body; and
a control device operable, in one control operation, to effect a decoupling of the load bearing body and the support body from one another, via spaced apart disposition thereof or the creation of a free space therebetween, in a manner such that the load bearing body supports the entire mass of the group of components, and operable, in another control operation, to effect a coupling of the load bearing body and the support body with one another such that both cooperate together in supporting the load.

2. A securing element according to claim 1, wherein the fluid volume is disposed between the load bearing body and the support body such that, in the other control operation of the control device, the load bearing body is in contact with the fluid volume in a manner in which oscillations are transferred from the load bearing body through the fluid volume.

3. A securing element according to claim 1, wherein the load bearing body, the support body, and fluid volume are arranged serially with the support body intermediate the load bearing body and the fluid volume such that the fluid volume is in contact with a side of the support body which does not face the load bearing body, whereby, in the other control operation, the load bearing body is at least partially in direct contact with the support body.

4. A securing element according to claim 3, wherein the enclosure enclosing the fluid volume comprises a membrane operable to maintain the fluid volume at a spacing from the support body.

5. A securing element according to claim 1, wherein the load bearing body has a hollow conical shape.

6. A securing element according to claim 5, wherein the outer periphery of the hollow conically shaped load bearing body is connected with the housing.

7. A securing element according to claim 1, wherein the enclosure enclosing the fluid volume is a membrane and the load bearing body includes an inwardly oriented, concavely curved surface which, starting at the outer periphery, comes into contact in a progressive uninterrupted manner with a selected one of a correspondingly configured surface of the support body and the membrane enclosing the fluid volume.

8. A securing element according to claim 1, wherein the enclosure enclosing the fluid volume is a membrane and further comprising an inlet communicating with the fluid volume, the inlet being selectively openable to permit variation of the volume of the fluid volume via a pressure equalization of the fluid volume with the atmosphere, whereby the membrane can be disposed at a selected one of a disposition in contact with the load bearing body and a disposition spaced from the load bearing body.
